(19) United States
(12) Patent Application Publication
(10) Pub. No.: US 2007/0020387 A1
(43) Pub. Date: Jan. 25, 2007

(54) Facture of shining keyboard and mouse

(76) Inventor: Hui-Hu Liang, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/184,884

(22) Filed: Jul. 20, 2005

(51) Int. Cl. B05B 5/00; B05D 1/02; C23C 18/00

(52) U.S. Cl. 427/157; 345/176; 427/421.1

(57) ABSTRACT

This invention is an improved facture of shining keyboard and mouse, which applies the nontoxic and damp-proof high brightening organic material to make nanometer energy light accumulating powder that accords with environmental protection requirements, then concoct this manometer energy light accumulating power and transparent resin into solvent, and coat this solvent on keyboard or inner & external layer of mouse by spray-painting so as to make light accumulating layer, when this light accumulating layer has absorbed enough energy of light source, it may inspire this light accumulating layer to produce fluorescent effect.

### BACKGROUND OF THE INVENTION

1) Field of the Invention

This invention is an improved facture of shining keyboard and mouse, which applies the nontoxic and damp-proof high brightening organic material to make nanometer energy light accumulating powder that accords with environmental protection requirements, and concoct this manometer energy light accumulating power and transparent resin into solvent, then coat such solvent properly so as to make light accumulating layer by spray-painting, this light accumulating layer can be directly applied for keyboard and mouse, which can absorb energy of light source so that keyboard and mouse can shine based on this light accumulating layer.

2) Description of the Prior Art

The often seen fluorescent objects are mostly sprayed (or coated) by fluorescent agent and made from fluorescent material so as to produce fluorescent effect; because the fluorescent agent and fluorescent material make use of their brightening features that can supply fluorescent energy when ray is not enough (the more weaker the ray is, the more higher fluorescence it may supply), therefore, its fluorescent effect usually is very weak, and also brightness of this fluorescent object may be affected by environment, furthermore, this fluorescent energy cannot be reinforced, so it is difficult to last a long time, this is the biggest difficulty in its application; in addition, this fluorescent agent or fluorescent material contains toxicant that may hurt people or damage environment, if no caution is paid to the toxicant contained, its superfluous toxicity often make great damage that cannot be predicted. Therefore, it is unsafe to use it.

### SUMMARY OF THE INVENTION

1. Problem to be Solved:

(1) The often used fluorescent exposure effect are yellow and green, since it is similar to color of daily articles' indicator light, therefore, its fluorescent effect is not good as expected, so it isn't applicable for electric appliance.

(2) To release energy by its own fluorescent characteristic so that its fluorescent time is limited and efficiency will be weakening accordingly.

(3) The fluorescent agent or material with toxicity may hurt human's body and make damage to environment.

2. Solutions:

(1) This invention uses light accumulating powder to absorb energy of light source so as to extend fluorescent time and increase effect of fluorescent exposure efficiency.

(2) According to physics of product, this invention selects solvent external spraying or inner spraying mode with suitable physics and coats light accumulating powder properly over the surface of product so that this light accumulating powder can expose fluorescence and fully accords with application of product.

(3) The concocted solvent of this invention can be put into practical application based on the spraying and screen printing mode.

(4) This invention introduces organic material that cannot make damage to environmental protection, and also has nontoxic and damp-proof function.

### BRIEF DESCRIPTION OF THE DRAWINGS

FIG. 1 is a facture flow of this invention

FIG. 2 is a sketch map of mouse external spray painting of this invention

FIG. 3 is a sketch map of mouse inner spray painting of this invention

FIG. 4 is a sketch map of keyboard application of this invention

FIG. 5 is a sketch map of keycap etching of this invention

FIG. 6 is a ketch map of keycap printing of this invention

### DETAILED DESCRIPTION OF THE PREFERRED EMBODIMENTS

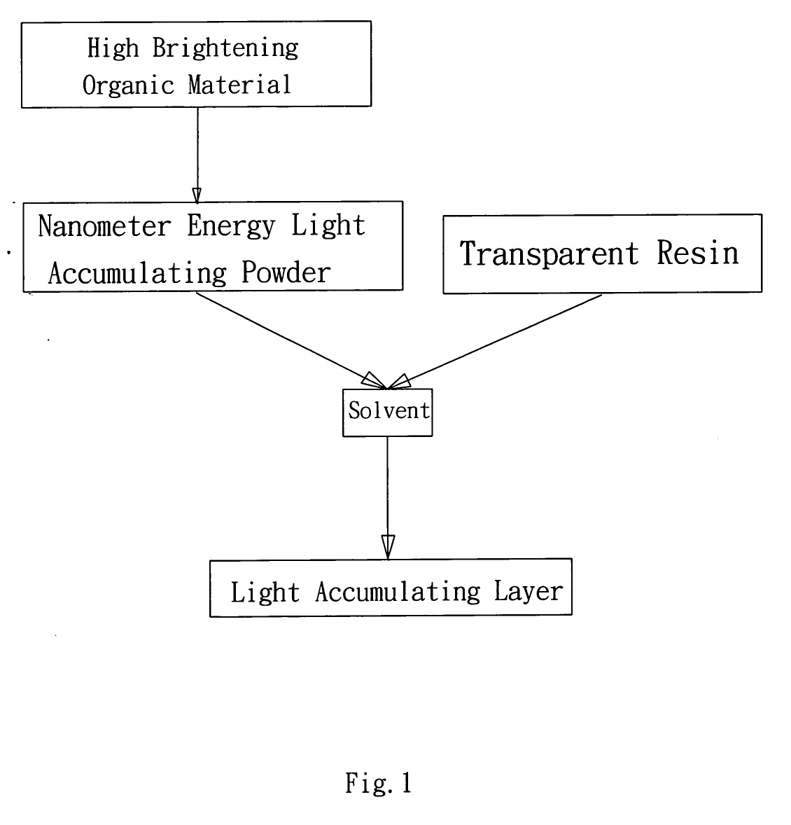

First of all, please refer to description of FIG. 1, it is an improved facture of shining keyboard and mouse, which applies the nontoxic and damp-proof high brightening organic material to make nanometer energy light accumulating powder based on nanometer technology; then concoct this manometer energy light accumulating power and transparent resin into solvent, coat properly one light accumulating layer by spray-painting.

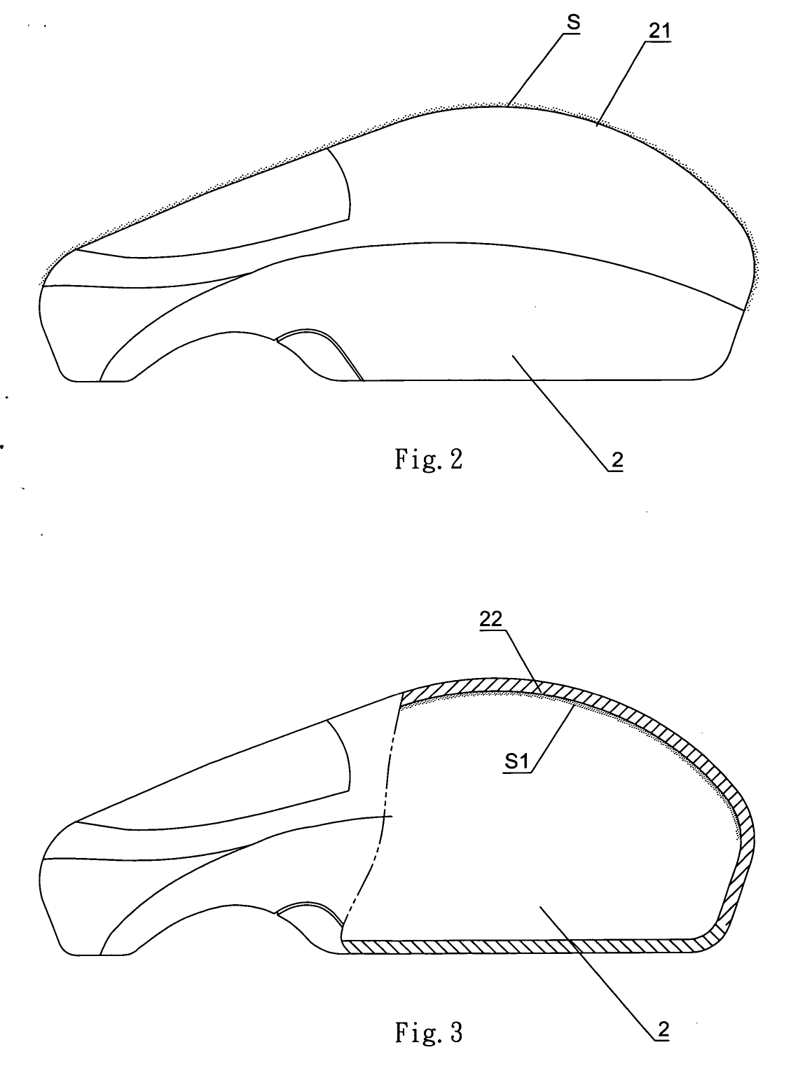

Secondly, please again refer to description of FIG. 2 and FIG. 3, this invention concocts nanometer energy light accumulating powder and transparent resin into solvent and coat properly over external layer 21 of mouse 2 so as to make light accumulating layer S, when light accumulating layer S has absorbed enough energy of light source, it may inspire light accumulating layer S to produce fluorescent effect (see FIG. 2); this invention concocts nanometer energy light accumulating powder and transparent resin into solvent and coat properly on inner layer 22 of mouse 2 by spraying so as to make light accumulating layer S1, when light accumulating layer S1 has absorbed enough energy of light source, it may inspire light accumulating S1 to produce fluorescent effect (see FIG. 3 for application).

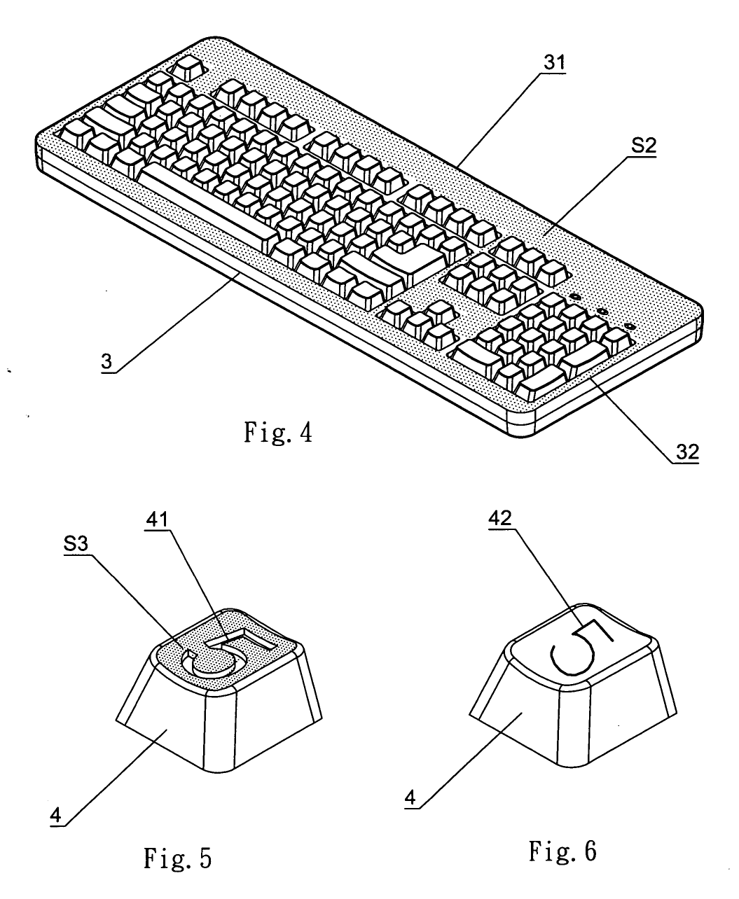

In addition, please again refer to description of FIG. 4, FIG. 5 and FIG. 6, this invention can also coat this solvent over external and inner layer 31 of keyboard 3 so as to make light accumulating layer S2, when light accumulating layer S2 has absorbed enough light source energy, it may inspire light accumulating layer S2 to produce fluorescent effect (refer to FIG. 4); the solvent is concocted by nanometer energy light accumulating powder and transparent resin, which can be coated properly on keycap 4 of keyboard 3 by spraying so that keycap may make light accumulating layer S3 on external layer of keycap 4, then etch the exposed word 41 or image by laser engraving, when this light accumulating layer S3 has absorbed light source energy, it may inspire light accumulating layer S3 to produce fluorescent effect, the etched parts may produce high contrast due to light accumulating layer S3 so as to reinforce exposure effect of word 41 or image (such as FIG. 5); the solvent concocted by nanometer energy light accumulating powder and transparent resin may print light accumulating layer 42 of word or image on keycap 4 by screen printing. When light accumulating layer 42 of word or image has absorbed enough energy of light source, it may inspire this light accumulating layer 42 to expose word or image in fluorescent effect (please refer to FIG. 6).

What is claimed is:

1. An improved facture of keyboard and mouse, mainly include:
a. Select nontoxic and damp-proof high brightening organic material according with environmental protection requirements.
b. Based on nanometer energy light accumulating powder by nanometer technology;
c. Concoct nanometer energy light accumulating powder and transparent resin into solvent;
Thereby, coat this solvent properly on keyboard or inner & external layer of mouse by spray-painting so as to make light accumulating layer, when this light accumulating layer has absorbed enough energy of light source, it may inspire this light accumulating layer to produce fluorescent effect.

2. As described in claim 1, it is an improved facture of shining keyboard and mouse, in which, this case is applicable for transparent inner sprayed light accumulating layer, meanwhile, make light accumulating layer absorb enough energy of light source so as to inspire it to produce fluorescent effect.

3. As described in claim 1, it is an improved facture of shining keyboard and mouse, in which, this case may etch the light accumulating layer by laser carving, the produced high contrast can promote exposure effect of word and image.

4. As described in claim 1, it is an improved facture of shining keyboard and mouse, in which, this case may increase circuit modular to produce light source on mouse and keyboard circuit board so as to extend fluorescent time of light accumulating powder and reinforce fluorescent efficiency.

5. As described in claim 1, it is an improved facture of shining keyboard and mouse, in which, this case can print word or image on surface of keycap with solvent concocted by light accumulating powder and transparent resin based on screen printing mode so that this word or image may produce fluorescent effect.
